(19) United States
(12) Patent Application Publication
(10) Pub. No.: US 2007/0265911 A1
(43) Pub. Date: Nov. 15, 2007

(54) ADVERTISING AND COMMUNICATION SYSTEM AND METHOD THEREFOR

(76) Inventor: Ted S. Rondeau, Phoenix, AZ (US)

Correspondence Address: WEISS & MOY PC, 4204 NORTH BROWN AVENUE, SCOTTSDALE, AZ, 85251, US

(21) Appl. No.: 11/383,044

(22) Filed: May 12, 2006

(51) Int. Cl. G07G 1/14; G06Q 30/00; H04Q 7/38; G08B 1/08

(52) U.S. Cl. 705/14; 340/539.11; 455/414.1

(57) ABSTRACT

A wireless advertisement and communication system uses a wireless transmitting unit for sending communication and promotional notices to registered guests of a hotel. The wireless transmitting unit sends the communication and promotional notices to a predefined area. A plurality of receiving units is programmed to receive the communication and promotional notices. Each registered guest of the hotel receives at least one receiving unit at check-in. Each receiving unit receives the communications and promotional notices when the receiving unit is located in the predefined area.

### FIELD OF THE INVENTION

The present invention relates to advertising system, and more specifically, to a wireless advertisement system for hotels, resorts, casinos, and the like wherein (hereinafter hotel) each person who registers at the aforementioned will receive a wireless receiver similar to a small PDA, the wireless receiver being used to receive different promotional advertisements.

### BACKGROUND OF THE INVENTION

Tourism is a multi-billion dollar industry. Different hotel and resort companies (hereinafter hotels) are continuously battling one another to lure customers to stay at their hotel. Even when a client decides to stay at one hotel, the client may want to go to a competing hotel chain to gamble, eat, shop, etc. This is especially problematic in areas like Las Vegas, Atlantic City, and other gambling and resort areas. In these cities, many tourists may stay at one hotel but gamble, eat and spend other monies at a competing hotel.

In order to solve the above problem, many hotel companies have begun to offer incentives for people who are staying at their hotel. These incentives can range from discounts to shows, meals, spa treatments, and the like. A problem arises though on how to notify hotel guests of the different incentives a hotel may offer. Some hotels will have signs placed around the hotel premises that notify the guest of different incentive offers. Some hotels may offer different incentives over a particular channel on the television located in the hotel room of the guest. Other hotels may just inform the guest of different incentives when the guest registers at the front desk.

While the above methods may work, they all suffer serious drawbacks. None of the above methods will allow a guest to immediately know of an incentive offered by the hotel. Furthermore, many of the above methods are not very affective in letting the guest know of current incentives. Many times, if a hotel guest does not see any of the incentives, they will leave the hotel and go to another competing hotel to look for certain services.

Therefore, a need exists to provide a device and method to overcome the above problem. The device and method must immediate notify guest of any current incentives offered by the hotel.

### SUMMARY OF THE INVENTION

In accordance with one embodiment of the present invention, a wireless advertisement and communication system is disclosed. The wireless advertisement and communication system uses a wireless transmitting unit for sending communication and promotional notices to registered guests of a hotel. The wireless transmitting unit only sends the communication and promotional notices to a predefined area. A plurality of receiving units is programmed to receive the communication and promotional notices. Each registered guest of the hotel receives at least one receiving unit at check-in. Each receiving unit receives the communications and promotional notices when the receiving unit is located in the predefined area.

The foregoing and other objects, features, and advantages of the invention will be apparent from the following, more particular, descriptions of the preferred embodiments of the invention, as illustrated in the accompanying drawing.

### BRIEF DESCRIPTION OF THE DRAWINGS

FIG. 1 is a simplified functional diagram of the present invention;

FIG. 2 is a perspective view of a notification unit used in the present invention;

FIG. 3 is a side view of the notification unit in a charging base;

FIG. 4 is a simplified function block diagram of the transmitting unit of the present invention.

FIG. 5 is a simplified functional block diagram of the circuitry of the notification unit.

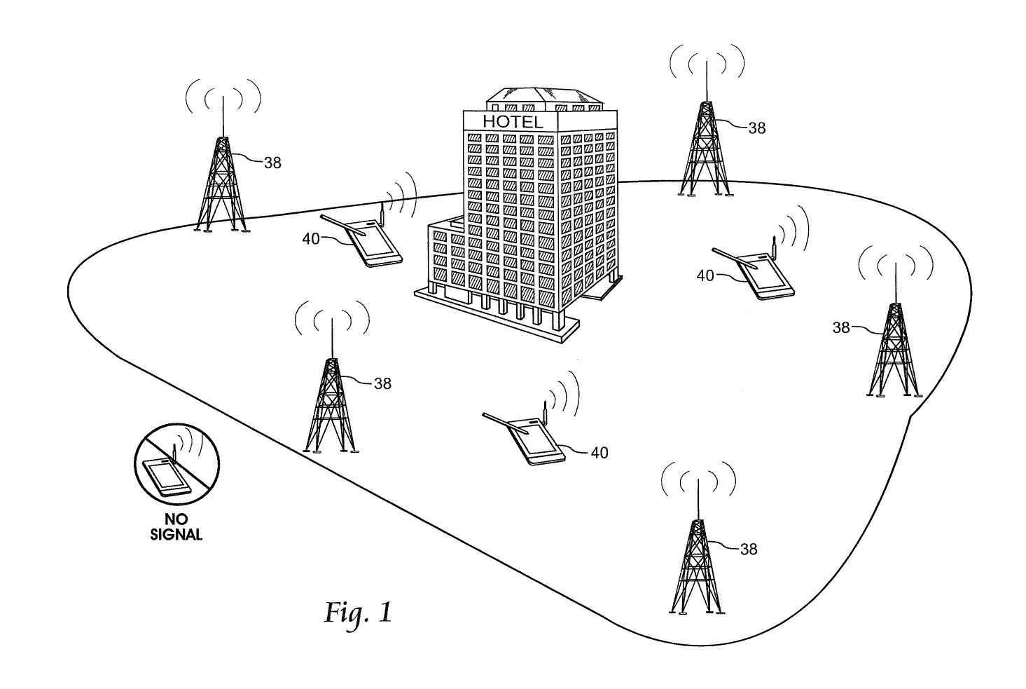

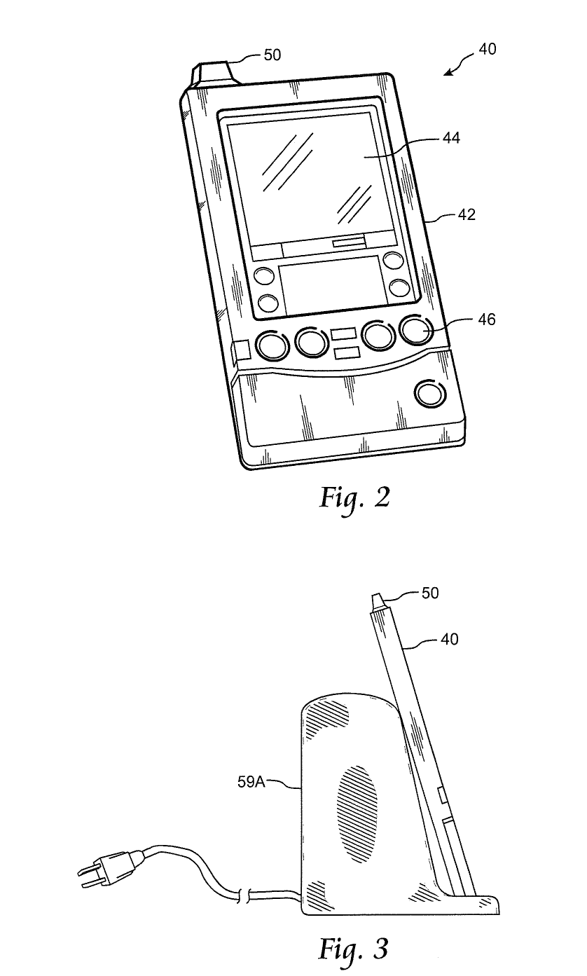

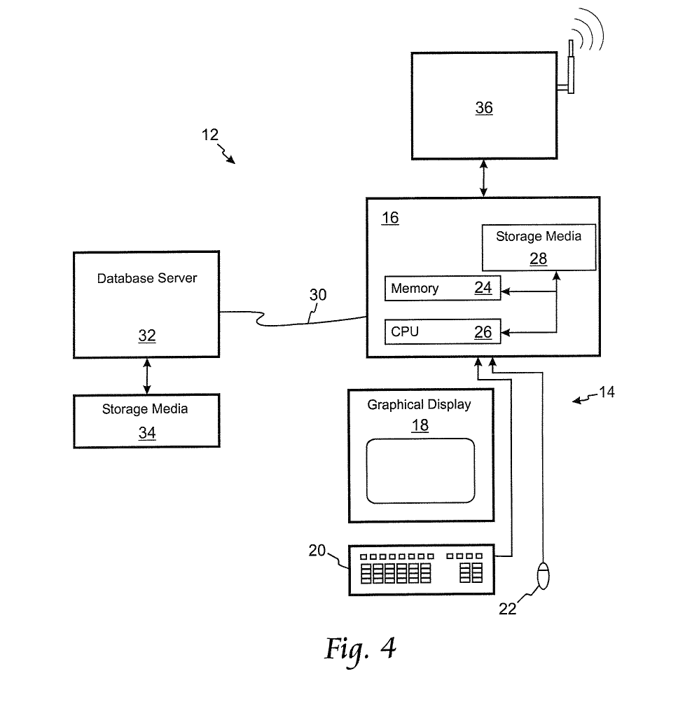

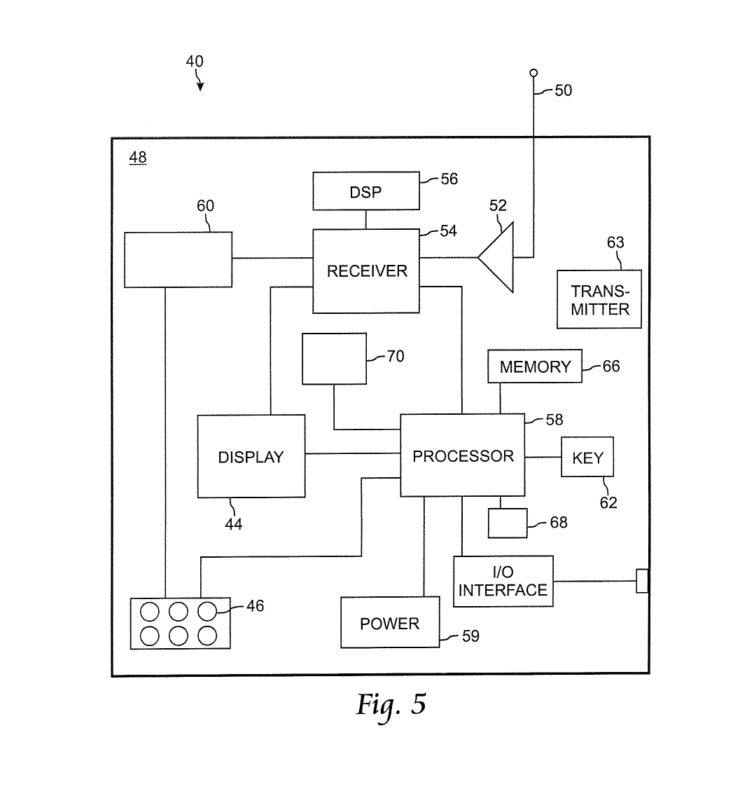

Common reference numerals are used throughout the drawings and detailed description to indicate like elements.

### DETAILED DESCRIPTION

Referring to the Figures, a wireless notification system 10 is shown. The wireless notification system 10 is used to immediately notify hotel guest of any incentives the hotel may be offering to guest who are registered/staying at their hotel. Incentives may include dinning specials, gambling events, free slot machine pulls, room specials, entertainment specials, spa specials, souvenir specials, and the like. The listing of the above is given as an example and should not be seen as to limit the scope of the present invention. The wireless notification system 10 will only transmit the notification of the incentives in a pre-defined area 11 (i.e., within the vicinity of the hotel property). Thus, people must remain in or around the pre-defined area in order to receive the notification.

The system 10 is generally comprised of a main transmitting unit 12. The main transmitting unit 12 is comprised of a computer 14. The computer 14 will have a processor unit 16 and a display 18. Input devices are coupled to the processor unit 16. The input devices may be a keyboard 20, a mouse 22, and the like. Through the execution of program instructions forming a computer program product within the computer 14, notification of incentives are sent to the different notification units 40.

The program instructions may be located within a memory 24 of the processor unit 16 and executed by a central processing unit 26 (CPU). Any data stored from the running of the program instructions may be stored entirely within a storage media 28 and/or the memory 24. Alternatively, the computer 14 may be coupled via a connection 30 to a network such as a local-area network (LAN), wide-area network (WAN) or the Internet. The connection 30 may be a wired connection, a wireless connection, or the like. In a network implementation, the program instructions may be located within a database server 32. Any data stored such as test results and the like may be stored in a storage media 34 coupled to the database server 32.

The input devices may be used in conjunction with program instructions located within the memory 24 and executed by the central processing unit 26 (CPU) to form textual and/or graphical notification of incentives. Alternatively, the textual and/or graphical notification of incentives may be loaded onto or stored in a memory of the processor unit 16. When desired, one or more textual and/or graphical notification of incentives is sent to a transmitting circuit 36. The transmitting circuit 36 will then send the notification of incentive to a plurality of wireless transmitters 38 located around the hotel property 11. The transmitting circuit 36 may be hardwired to each wireless transmitter 38. Alternatively, the transmitting circuit 36 may be wirelessly coupled to each wireless transmitter 38. If the transmitting circuit 36 is wirelessly coupled to each wireless transmitter 38, the transmitting circuit 36 may send a coded notification of incentive to each wireless transmitter 38 to prevent tampering of the wireless notification system 10.

The wireless transmitters 38 will be located on all floors of the hotel where guest have access. The wireless transmitters 38 will also be located outside of the hotel around the property 11 of the hotel. The wireless transmitters 38 will wirelessly transmit the notification of incentive. As shown in the drawings, each wireless transmitter 38 will transmit the notification of incentive in a predefined area. Outside of the predefined area, the notification of incentive will not be received. This will encourage guest of the hotel to stay within the predefined area in order to receive the notification of incentive.

Each guest that is registered at the hotel will receive a notification unit 40. The notification unit 40 is used to receive the notification of incentive that is sent out via the wireless transmitters 38. Text messages or other messages may also be sent to the notification unit 40. These messages may include but are not limited to: when a guest has a telephone call/message; an emergency situation regarding a guest; a package/message is at the front desk; and the like. As stated above, if the notification unit 40 is within the predefined area 11 (i.e., hotel and hotel grounds), the notification of incentive and other messages (hereinafter notification of incentive) will be received on the notification unit 40. If the guest leaves the hotel grounds 11 with the notification unit 40, the notification unit 40 will not receive the notification of incentive.

Each notification unit 40 is similar to a small Personal Digital Assistant (PDA). The notification unit 40 will have a housing unit 42. An opening is formed in the housing unit 42. The opening is used to mount a display 44 in the housing. The display 44 is used to show the notification of incentive that has been transmitted as well as other operating features of the notification unit 40. A plurality of buttons 46 are formed in the housing unit 40. The buttons 46 are used to control operation of the notification unit 40.

The housing unit 42 is used to store and protect a receiving circuit 48. The receiving circuit 48 is used to receive and display the notification of incentive as well as to perform a plurality of different features which will be disclosed below. The receiving circuit has an antenna 50. The antenna 50 is used to receive signal transmissions from the wireless transmitters 38. The signal transmissions received by the antenna 50 are generally sent to an amplifier 52 which increases the strength of the signal transmission received by the antenna 50. The output of the amplifier 52 is sent to the receiver 54. The receiver 54 decodes and compares the signal to a predefined signal to determine if the signal received is from the wireless notification system 10. If so, the decode signal is sent to the display 44. A digital signal processor (DSP) 56 may be coupled to the receiver 54. The DSP 56 is a highly customized processor designed to perform signal-manipulation calculations at high speed.

A microprocessor 58 is also coupled to the receiver 54. The microprocessor 58 handles all of the housekeeping chores for the buttons 46 and the display 44, deals with command and control signaling, and also coordinates the rest of the functions of the notification unit 40. A memory section of the microprocessor 58 will generally store an operating system for the notification unit 40. In accordance with one embodiment of the present invention, the microprocessor 58 is programmed to translate the notification of incentive, directions, and other functions of the notification unit 40 into different languages. A button 46 may be used to switch between different languages.

The receiving circuit 48 will have a power supply 59. The power supply 59 is used to power the different components of the receiving circuit 48. The power supply 59 is generally a DC power supply such as a battery or the like. A rechargeable battery may be used. In such case, a charging unit 59A may be placed in a guest room to recharge the power supply 59. Charging units 59A may be placed in other locations of the hotel as well.

A signaling unit 60 may be coupled to the receiver 54. The signaling unit 60 will inform the user that a notification of incentive signal has been received by the notification unit 40. The signaling unit 60 may sound an audible alarm such as a beeping noise to indicate that an incentive offer has been received. Alternatively, the signaling unit 60 may vibrate the notification unit 40. Another alternative is for the signaling unit to provide a visual signal such as a flashing LED to indicate a receipt of an incentive offer. The signaling unit 60 may provide one or more of the above features. If more than one signaling means is provided, a user may select a desired signaling means by pressing one of the predefined buttons 46.

As stated above, the notification unit 40 may perform other features. In accordance with one embodiment of the present invention, the notification unit 40 may be used to unlock a guest room of the user. The notification unit 40 may have a key unit 62 coupled to the microprocessor 58. The key unit 62 will allow one to unlock a guest room of the user. By pressing one of the buttons 46 a coded signal is sent through a wireless transmitter 63. The coded signal is used to unlock the door lock. Alternatively, the notification unit 40 may be pressed against a door lock so that the key unit 62 engages the door lock thereby unlocking the door lock. An I/O interface 64 is generally coupled to the microprocessor 58. The I/O interface 64 is used to program the key unit 62 to open a specific hotel door lock.

The microprocessor 58 may also function as a radio frequency module. This would allow the microprocessor 58 to remotely control different features in the hotel room via the wireless transmitter 63. For example, the microprocessor 58 programmed as a radio frequency module may allow a person to turn on the lights in the hotel room, adjust the thermostat, control a television and/or radio, and the like. Alternatively, a base unit (not shown) may be located on a wall of the hotel room. When the notification unit 40 is placed in the base unit, the base unit will activate the lights in the room, adjust the thermostat to a predefined level, charge the notification unit, and the like. Furthermore, by placing the notification unit 40 in the base unit, the base unit may notify the hotel that the guest is in the hotel room.

The notification unit 40 may also be used to display a map of the hotel. The map may show all interior features as well as amenities located on the hotel grounds. The notification unit 40 may store a map of the hotel grounds in a memory device 66 coupled to the microprocessor 58. A user can bring up a map by pressing a designated button 46. Different buttons 46 may be used to zoom in and out on the map. Alternatively, the hotel can upload the map when a guest checks into the hotel. The upload may be used to show the room location of the guest. In accordance with another embodiment of the present invention, a city map may be stored in memory. The city map may show other hotels in the city owned by the same company.

The notification unit 40 may further have a tracking unit 68 coupled to the microprocessor 58. The tracking unit 68 would be used to allow the hotel to track the location of the notification unit 40. This will allow one to locate a notification unit 40 if a guest should lose the notification unit 40. In accordance with one embodiment of the present invention, the tracking unit 68 is an RFID tag unit.

The notification unit 40 may further have an audible alarm unit 70 coupled to the microprocessor 58. The audible alarm unit 70 will sound an audible alarm when a user presses a predefined button 46 or sequence of buttons 46. Alternatively, a pull pin may be used to sound the audible alarm unit 70. To deactivate or turn off the audible alarm unit 70, one can press the predefined button 46 or sequence of buttons 46 or reinsert the pull pin. The audible alarm unit 70 may work in conjunction with the tracking unit 68. If the audible alarm unit 70 is activated, the tracking unit 68 would allow the hotel to find the location of the guest in order to render aid.

The notification unit 40 may further be used as a credit/debit card. In this manner, the notification unit 40 would be used in a similar manner as a frequent gaming card. A user may couple the notification unit 40 to a gaming device via the I/O interface 64 of the receiving circuit 48. The notification unit 40 can then debit/credit the guest account based on the winnings/losses of the guest. In a like manner, if a guest decides to purchase food, drink, services, and the like from a hotel store, restaurant, spa, etc., the hotel may charge the notification unit 40 via the I/O interface 64. All charges may then be downloaded and charged to the guest when the guest checks out of the hotel.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A wireless advertisement and communication system comprising:
a wireless transmitting unit for sending communication and promotional notices to registered guests of a hotel, the wireless transmitting unit sending the communication and promotional notices to a predefined area; and
a plurality of receiving units programmed to receive the communication and promotional notices, wherein each registered guest of the hotel receives at least one receiving unit at check-in, each receiving unit receiving the communications and promotional notices when the receiving unit is located in the predefined area.

2. A wireless advertisement and communication system in accordance with claim 1 wherein the wireless transmitting unit comprises:
a processing unit;
a display coupled to the processing unit;
an I/O interface coupled to the processing unit;
a transmitting unit coupled to the processing unit; and
a plurality of wireless transmitters coupled to the transmitting unit for sending the communication and promotional notices to the plurality of receiving units.

3. A wireless advertisement and communication system in accordance with claim 2 wherein the transmitting unit wirelessly sends the communication and promotional notices to the plurality of wireless transmitters.

4. A wireless advertisement and communication system in accordance with claim 1 wherein each receiving unit comprises:
a housing;
a receiving circuit stored in the housing for receiving and translating the communication and promotional notices;
a display mounted to the housing for showing the communication and promotional notices sent to the receiving unit; and
a plurality of buttons coupled to the receiving circuit to control operation of the receiving unit.

5. A wireless advertisement and communication system in accordance with claim 4 wherein the receiving circuit comprises:
an antenna for receiving the communication and promotional notices sent by the wireless transmitting unit;
an amplifier coupled to the antenna;
a receiver coupled to an output of the amplifier and to the display;
a processor coupled to the receiver and the plurality of buttons for controlling operation of the receiving unit; and
a power supply for power the receiving circuit.

6. A wireless advertisement and communication system in accordance with claim 5 wherein the receiving circuit further comprises a digital signal processor coupled to the receiver to process the communication and promotional notices sent by the wireless transmitting unit.

7. A wireless advertisement and communication system in accordance with claim 5 wherein the receiving circuit further comprises an input/output interface coupled to the processor for uploading and downloading data from the receiving unit.

8. A wireless advertisement and communication system in accordance with claim 5 wherein the receiving circuit further comprises a notification unit coupled to the receiver for indication when the receiving unit has received the communication and promotional notices sent by the wireless transmitting unit.

9. A wireless advertisement and communication system in accordance with claim 5 wherein the receiving circuit further comprises a key unit coupled to the processor for unlocking a door of the hotel.

10. A wireless advertisement and communication system in accordance with claim 9 wherein the key unit wirelessly unlocks the door of the hotel.

11. A wireless advertisement and communication system in accordance with claim 5 wherein the receiving circuit further comprises an alarm unit coupled to the processor for sounding an alarm.

12. A wireless advertisement and communication system in accordance with claim 5 wherein the receiving circuit further comprises a tracking unit coupled to the processor for indicating a location of the receiving unit.

13. A wireless advertisement and communication system in accordance with claim 5 wherein the processor translates the communication and promotional notices to different languages.

14. A wireless advertisement and communication system comprising:
a wireless transmitting unit for sending communication and promotional notices to registered guests of a hotel, the wireless transmitting unit sending the communication and promotional notices to a predefined area, wherein the wireless transmitting unit comprises:
a processing unit;
a display coupled to the processing unit;
an I/O interface coupled to the processing unit;
a transmitting unit coupled to the processing unit; and
a plurality of wireless transmitters coupled to the transmitting unit for sending the communication and promotional notices to the plurality of receiving units; and
a plurality of receiving units programmed to receive the communication and promotional notices, wherein each registered guest of the hotel receives at least one receiving unit at check-in, each receiving unit receiving the communications and promotional notices when the receiving unit is located in the predefined area, wherein each receiving unit comprises:
a housing;
a receiving circuit stored in the housing for receiving and translating the communication and promotional notices, wherein the receiving circuit comprises:
an antenna for receiving the communication and promotional notices sent by the wireless transmitting unit;
an amplifier coupled to the antenna;
a receiver coupled to an output of the amplifier and to the display;
a processor coupled to the receiver for controlling operation of the receiving unit; and
a power supply for power the receiving circuit;
a display mounted to the housing for showing the communication and promotional notices sent to the receiving unit; and
a plurality of buttons coupled to the receiving circuit to control operation of the receiving unit.

15. A wireless advertisement and communication system in accordance with claim 14 wherein the receiving circuit further comprises a digital signal processor coupled to the receiver to process the communication and promotional notices sent by the wireless transmitting unit.

16. A wireless advertisement and communication system in accordance with claim 14 wherein the receiving circuit further comprises an input/output interface coupled to the processor for uploading and downloading data from the receiving unit.

17. A wireless advertisement and communication system in accordance with claim 14 wherein the receiving circuit further comprises a notification unit coupled to the receiver for indication when the receiving unit has received the communication and promotional notices sent by the wireless transmitting unit.

18. A wireless advertisement and communication system in accordance with claim 14 wherein the receiving circuit further comprises a key unit coupled to the processor for unlocking a door of the hotel.

19. A wireless advertisement and communication system in accordance with claim 14 wherein the receiving circuit further comprises an alarm unit coupled to the processor for sounding an alarm.

20. A wireless advertisement and communication system in accordance with claim 14 wherein the receiving circuit further comprises a tracking unit coupled to the processor for indicating a location of the receiving unit.
